(19) United States
(12) Patent Application Publication
(10) Pub. No.: US 2010/0308556 A1
(43) Pub. Date: Dec. 9, 2010

(54) Bicycles driven through driver units

(76) Inventors: Qi Nong Jin, Shanghai (CN); Jian Jin, Shanghai (CN); Gang Guo, Shanghai (CN)

Correspondence Address: DAVID AND RAYMOND PATENT FIRM, 108 N. YNEZ AVE., SUITE 128, MONTEREY PARK, CA, 91754, US

(21) Appl. No.: 12/385,226

(22) Filed: Apr. 2, 2009

(30) Foreign Application Priority Data
Feb. 13, 2009 (CN) 200920067711.5

(51) Int. Cl. B62M 9/04

(52) U.S. Cl. 280/210

(57) ABSTRACT

This invention relates to the drive technique of bicycles, particularly two-wheel and rear-wheel driven ones. This invention comprises a front-wheel driver unit which moves rectilinearly and directly matches the front-wheel ratchet wheel, to drive the front wheel. It also contains a curvilinear rear-wheel driver unit which moves along a curve and directly matches the rear-wheel ratchet wheel to drive the rear wheel. The two-wheel driven bicycle has a head tube in the front to form a bracket to support the cyclist's shoulders so that the cyclist, while using his or her arms to steer the bicycle and drive the front wheel, does not have to make big effort to support his/her upper body. In the case of the rear-wheel driven bicycle, the identical rear-wheel driver unit used for said two-wheel driven bicycle is used, and the front wheel and the handlebars are just the same as that of a conventional bicycle. Higher drive efficiency can be achieved by using driver units to directly drive cycle wheels, because it converts the maximum effort of the cyclist's arms and/or legs into the rotational moment to drive the bicycle forward. Moreover, the bicycle structure is simple.

### FIELD OF THE INVENTION

The present invention relates to bicycle drive technique, in particular to bicycles driven directly through driver units.

### BACKGROUND OF THE INVENTION

A conventional bicycle makes use of a system comprising pedals, cranks, chain-wheels and chains to drive the rear wheel.

Please refer to FIG. 1—an analytical illustration of forces acting on the pedal of a conventional bicycle, where A is the pedal, B is the crank, and C is the chain-wheel. As pedal A moves round its axis, an angle of θ is formed between its radius and the vertical line. And as pedal A rotates, it is acted on by the downward force F applied by the cyclist through his or her leg, and F can be divided into two components F₁ and F₂; F₁ points to the tangential direction of the circumference whereas F₂ is the normal force towards the center of the shaft along the normal direction of the circumference. The tangential force F₁ forms the moment of force driving the bicycle forward, and the normal force F₂ is wasted because its direction makes it impossible to produce a useful moment of force. As angle θ varies from 0 to π, the cyclist produces work with his or her legs, and the tangential component F₁ drives the bicycle forward; as it varies from π to 2π, the cyclist doesn't produce any work because he or she only takes the legs back. And as the cyclist's two legs alternate to produce work with angle θ varying within the range of 0 and π, the F₁ works to drive the bicycle forward. To find the average value F̅₁, where the angle θ changes from 0 to π:

From FIG. 1, we get:

$${F}_{1} = F Sin θ$$

$$\overline{{F}_{1}} = \frac{F}{b - a} {\int }_{a}^{b} Sin θ d θ = \frac{F}{π - 0} {\int }_{0}^{π} Sin θ d θ$$

$$\overline{{F}_{1}} = \frac{F}{π} ( - COS θ {\vert}_{0}^{π} ) = \frac{F}{π} [ - ( - 1 - 1 ) ]$$

$$\overline{{F}_{1}} = \frac{2}{π} F ≅ 0.637 F$$

We may draw a conclusion from the above equation that in average only about a 63.7% of the downward force applied by the cyclist's legs is employed to form the rotational moment driving the bicycle forward, while the remaining 36.3% goes wasted. In short, the efficiency of drive with a bicycle based on the pedal-crank-chain-wheel-chain system is 63.7%.

The front wheel of a conventional bicycle is designed merely to steer the forward direction of the bicycle without any contribution to its forward movement. While steering the front wheel, the cyclist's arms also have to take on the weight of his or her upper body, and as a result, his or her arms' muscles will become stiff and tired with time, yet this part of energy from arms is idle work.

It is shown by U.S. Pat. Nos. 6,986,520, 6,419,255, 6,446,985, 6,182,991, 6,068,279, 5,390,946, 5,397,142, 5,332,244, 5,324,057, 5,253,889, 5,224,725, and 4,479,660 that two-wheel driven bicycles usually adopt the pedal-crank-chain-wheel drive system wherein a part of the force applied by cyclist's legs is used to drive the rear wheel and the remaining part is used to drive the front wheel through a driven shaft or flexible shaft or chain.

U.S. Pat. No. 4,773,662 shows another drive technique for a two-wheel drive bicycle, which, while adopting the pedal-crank-chain-wheel drive system to drive the rear wheel by the cyclist with the legs, entails a chain-wheel-chain system driven by the handlebar and crank mounted specifically on the bicycle's forefront to bring into action another set of chain-wheel-chain mechanism to drive the front wheel by the cyclist using hands.

The above-mentioned 13 examples of the prior art regarding the two-wheel drive techniques for bicycles exhibit such disadvantages: the cyclist has to carry the weight of the upper part of the body with his or her arms; the way the pedal-crank-chain-wheel system works leads to low efficiency of drive; and the structure thus entailed is usually complicated.

Drive techniques presented in U.S. Pat. Nos. 6,723,029, 6,412,802, 6,090,002, 5,236,211, and 5,540,111 show that doing away with the crank and keeping the chain-wheel-chain system to drive the rear wheel of a conventional bicycle results in a more complicated structure of bicycle than that of conventional ones.

### SUMMARY OF THE INVENTION

A preferred embodiment of the present invention presents a two-wheel driven bicycle that uses driver units to directly drive the ratchet wheels and bicycle wheels, mainly for the purpose of overcoming the deficiencies of existing techniques. The cyclist, while using arms to control the direction of the bicycle, no longer needs to endeavor to prop up the upper part of his or her body, but will make effort whatsoever to drive the front wheel. The way the driver unit works leads to higher efficiency of drive, for the effort by arms or legs can be converted into a maximum of rotational moment driving the bicycle forward. The preferred embodiment of the present invention totally gets rid of the chain-wheel-chain-based drive system of a conventional bicycle, resulting in a much simpler structure.

The preferred embodiment of the present invention is realized in a way as follows:

A two-wheel driven bicycle is firstly characterized by: there is a bracket mounted above its head tube so that when the cyclist puts his or her shoulders against the bracket, the rotatory front fork doesn't rotate with it but remains vertical to the bicycle frame.

A two-wheel driven bicycle has a second characteristic: the front-wheel driver unit engages the front-wheel ratchet wheel and moves rectilinearly to directly drive the front-wheel ratchet wheel and the front wheel, and the curvilinear rear-wheel driver unit engages the rear-wheel ratchet wheel and moves along a curve to directly drive the rear wheel ratchet wheel and the rear wheel. Said front-wheel driver unit refers to a linear metal strip inside which bar rollers are inserted at equal space, and said rear-wheel driver unit is a curvilinear metal device inside which bar rollers are inserted at equal space. Said ratchet wheel refers to a bicycle part called “free wheel” of which the working principle and internal structure is known to all familiar with the bicycle art and needs no further description here.

Said two-wheel driven bicycle has a third characteristic: the cyclist holds the handlebars of the front-wheel driver unit mechanism to control the forward direction and to push the front-wheel driver unit downward to directly drive the front-wheel ratchet wheel and the front wheel.

Said two-wheel driven bicycle has a fourth characteristic: the driver unit of the front wheel is situated at the lower part of its crust, and the crust has a long opening on the external side of its upper part and is open with its lower part.

Said two-wheel driven bicycle has a fifth characteristic: the handlebar of the front-wheel driver unit mechanism is linked to the upper end of the front-wheel driver unit through the connecting rod, and the connecting rod is surrounded by a spring means.

Said two-wheel driven bicycle has a sixth characteristic: the front-wheel driver unit relies on the cyclist' retracting his or her arms and the elasticity of said spring means to return to its origin:

Said two-wheel driven bicycle has a seventh characteristic: the rear-wheel driver unit is linked to the mid point of the crank, and the crank is connected to the crank shaft which is fixed to the rear end of the frame at one end and the pedal at the other.

Said two-wheel driven bicycle has an eighth characteristic: the rear-wheel driver unit is curvilinear and engages the rear-wheel ratchet wheel.

Said two-wheel driven bicycle has a ninth characteristic: the pedal moves downward, and the crank rotates around its shaft and makes the rear-wheel driver unit move downward along a curve to directly drive the rear-wheel ratchet wheel and the rear wheel.

Said two-wheel driven bicycle has a tenth characteristic: the rear-wheel driver unit is placed inside the crust having a curve-shaped opening on the side of its lower part.

Said two-wheel driven bicycle has an eleventh characteristic: the rear-wheel driver unit relies on the elasticity of said spring means, or the shoes that can fit neatly into the pedal, or the pull of steel wire, to return to its origin.

Based on the aforementioned approach and structure of the present invention, as the two-wheel driven bicycle driven directly by said driver units is concerned, the cyclist no more needs to prop up the upper part of his or her body with arms, for the bracket mounted on the head tube supports the upper part of the cyclist's body and thus allow the cyclist to hold the handlebars of the front-wheel driver unit mechanism and control the forward direction of the bicycle.

The cyclist pushes the handlebars downward to press the spring means and the connecting rod makes the front-wheel driver unit move downward to directly drive the front-wheel ratchet wheel and the front wheel. Meanwhile, the cyclist propels the pedal with the legs and the crank makes the rear-wheel driver unit move downward along a curve to directly drive the ratchet wheel of the rear wheel and the rear wheel.

When it comes to the front-wheel driver unit mechanism adopted by the two-wheel driven bicycle as the preferred embodiment of the present invention, the front-wheel driver unit moves downward in the tangential direction of the front-wheel ratchet wheel and directly drives the front wheel to rotate forward, resulting in the force applied by the cyclist's arms being 100% converted into the rotational moment driving the front wheel forward.

With regard to the rear-wheel driver unit mechanism adopted by the two-wheel driven bicycle as the preferred embodiment of the present invention, the crank rotates around the crank shaft, and the rear wheel driver unit moves downward along a curve in the tangential direction of the rear-wheel ratchet wheel to directly drive the rear wheel rotating forward. Assume the rotation angle of the crank is θ, and when θ equals to 30° (π/6), the following theoretic calculations can be conducted:—

$${F}_{1} = F Sin θ$$

$$\overline{{F}_{1}} = \frac{F}{b - a} {\int }_{a}^{b} Sin θ d θ = \frac{F}{\frac{π}{6}} {\int }_{\frac{π}{2}}^{\frac{π}{2} + \frac{π}{6}} Sin θ d θ$$

$$\overline{{F}_{1}} = \frac{F}{\frac{π}{6}} ( - COS θ {\vert}_{\frac{π}{2}}^{\frac{π}{2} + \frac{π}{6}} ) = \frac{6 F}{π} [ - ( - \frac{1}{2} - 0 ) ]$$

$$\overline{{F}_{1}} = \frac{3}{π} F ≅ 0.955 F$$

It therefore can be concluded that the preferred embodiment of the present invention for the two-wheel driven bicycle allows 95.5% of the force applied by the cyclist with the legs to be transformed into the rotational moment driving the rear wheel to rotate.

When it comes to mechanical efficiency, the two-wheel driven bicycle driven directly by the driver unit of the preferred embodiment of the present invention is better than a conventional one driven through pedals, cranks, chain wheels and chains. And the present invention does away with the chain-wheel-and-chain drive system of conventional bicycles and results in a simpler bicycle structure.

Compared with a conventional two-wheel driven bicycle, the preferred embodiment of the present invention discloses a two-wheel driven bicycle having the following advantages:—

(a) With the two-wheel driven bicycle as the preferred embodiment of the present invention, the cyclist has the weight of the upper part of his or her body propped up the bracket mounted on the head tube of the bicycle and thus avoids idle work and turns to drive the front wheel.

(b) When there is identical physical consumption, the two-wheel driven bicycle as the preferred embodiment of the present invention runs faster than a conventional one. And if the velocity remains identical, the two-wheel driven bicycle as the preferred embodiment of the present invention is superior to a conventional one in saving physical exertion.

(c) Both the front and rear wheel of the two-wheel driven bicycle as the preferred embodiment of the present invention are driving wheels whereas a conventional bicycle has its front wheel as driven wheel and rear wheel as driving wheel. And said two-wheel driven bicycle tends to climb a slope better than a conventional one.

(d) With the two-wheel driven bicycle as the preferred embodiment of the present invention, the cyclist “lies prostrate” on the bicycle, with the hands controlling the direction and driving the front wheel, showing both a division of labor and collaboration conforming to ergonomics.

(e) With the two-wheel driven bicycle as the preferred embodiment of the present invention, as the cyclist uses his or her limbs to drive the bicycle forward, there is a variety of possible combinations of operating postures, while a conventional bicycle allows only one single operating posture.

(f) With the two-wheel driven bicycle as the preferred embodiment of the present invention, the cyclist is able to extend and withdraw his or her arms, as he or she does with his or her legs, in a rhythmic way so that the muscles of the arms, breast, back, lumbar part and the legs can get balanced and coordinated exercise.

The second preferred embodiment of the present invention offers a bicycle of which the rear wheel is driven directly through the driver unit and has the first feature: it has a front wheel identical to that of a conventional bicycle, and above its head tube are the identical handlebars of a conventional bicycle.

Said bicycle driven directly through the driver unit has a second feature: it has a rear-wheel drive mechanism identical to that of the preferred embodiment of the present invention and with all its characteristics.

The third and fourth as well as other embodiments of the present invention are derived from the different combinations of the two wheels of the preferred embodiment of the present invention and will be described slightly later.

As are shown by the aforementioned preferred embodiments of the present invention, bicycles driven directly through the driver units demonstrate high efficiency of drive, save consumption for the cyclist, run faster, offer much more entertainment, and lead to more health benefits, and thanks to the doing away with the chain-wheel-chain drive system of a conventional bicycle, have a simple structure, low cost, and an easy access to industrialized production.

Those who are familiar with bicycle techniques are welcome to read this technical specification and better understand the other benefits defined by and in the claims of the present invention.

### BRIEF DESCRIPTION OF THE DRAWINGS

FIG. 1 is an analytical illustration of forces acting on the pedal.

FIG. 2 is a front view of the preferred embodiment of the present invention.

FIG. 3 is a top view of the preferred embodiment of the present invention.

FIG. 4 is a front view of the front-wheel driver unit mechanism.

FIG. 5 is an illustration of front-wheel driver unit and front-wheel racket wheel.

FIG. 6 is a front view of the rear wheel driver unit mechanism.

FIG. 7 is an illustration of rear-wheel driver unit and the rear-wheel ratchet wheel.

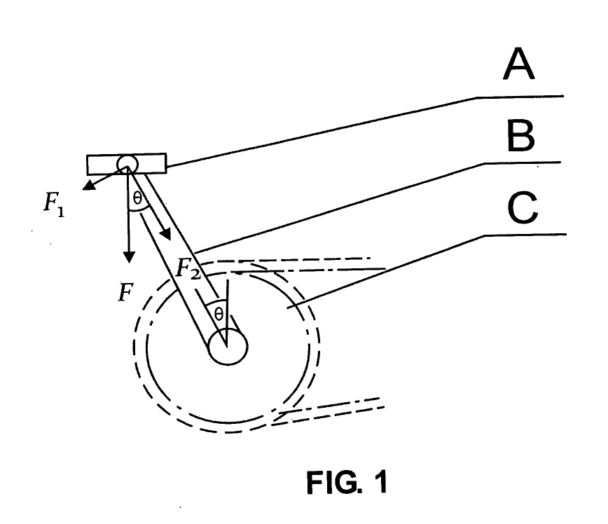

The seven figures herein stated are not to scale, so the invention is not limited to the present scale.

### DETAILED DESCRIPTION OF THE PREFERRED EMBODIMENTS

The preferred embodiment of the present invention, a two-wheel driven bicycle, has both its front wheel and rear wheel equipped with a driver unit mechanism, and has a bracket mounted above the head tube to support the cyclist's shoulders and the weight of the upper part of the cyclist's body, allowing the cyclist to use the arms to propel the front-wheel driver unit mechanism and thus drive the front wheel to rotate forward.

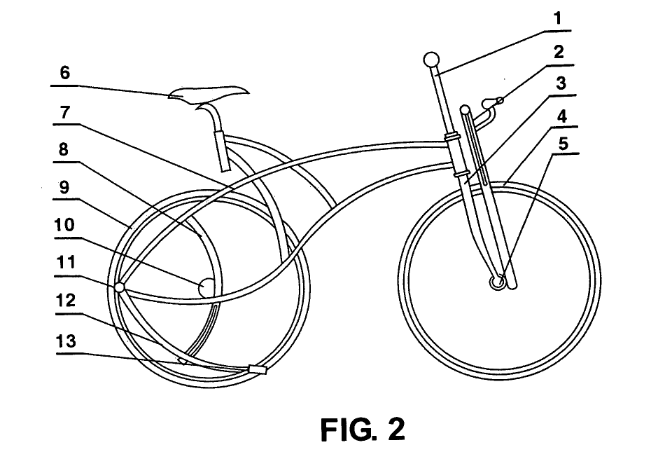

As show in FIG. 2, the two-wheel driven bicycle as the preferred embodiment of the present invention comprises a bracket 1, a front-wheel driver unit mechanism 2, a front fork 3, a front wheel 4, a front-wheel ratchet wheel 5, a saddle 6, a bicycle frame 7, a rear-wheel driver unit mechanism 8, a rear wheel 9, a rear-wheel ratchet wheel 10, a crank shaft 11, a crank 12, and a pedal13.

As shown in FIG. 3, one sees the bracket 1, the front-wheel driver unit mechanism 2, the front fork 3, the front wheel 4, the crank shaft 11, the rear wheel 9, the crank 12, the saddle 6, the pedal 13, and the frame 7.

The bracket 1 is mounted above the head tube of a conventional bicycle. If the cyclist puts his or her shoulders on the bracket 1, the bracket 1 remains perpendicular to the frame 7 and won't rotate with the front fork 3. If the cyclist doesn't place the shoulders on the bracket 1, the bracket 1 remains able to make the front fork 3 rotate. The way it works is described herein as: a conventional bicycle has a friction piece under its vertical stem, and said stem and the friction piece are inside the stem of the front fork; when the bolt at the top of the stem is screwed up, the friction between the friction piece under said stem and the stem of the front fork increases, enabling said stem and the handlebars to rotate along with the front fork. The present invention also places a friction piece under the stem of the bracket 1, and said friction piece is made of selected materials with a low friction coefficient, and meanwhile, the bolt at the top of the stem of bracket 1 is moderately screwed up. Said friction piece and said bolt of the bracket stem are identical in shape to that of a conventional bicycle and therefore are not otherwise illustrated here.

If the cyclist presses his or her shoulders on bracket 1, then, as the front fork 3 rotates, the friction between the stem of bracket 1 and the stem of front fork 3 is less than that between the cyclist' shoulders and bracket 1, and the bracket 1 remains perpendicular to the frame 7 and doesn't rotate along with the front fork 3. If the cyclist doesn't press the shoulders on the bracket 1, then, as the bracket 1 rotates, the friction between the stem of the bracket 1 and the stem of the front fork 3 is large enough to make front fork 3 rotate.

The bracket 1 is coated with soft substance to support the shoulders and breast of the cyclist, who, while riding the two-wheel driven bicycle, has the upper part of his or her body supported by the bracket 1 and thus free his or her arms from supporting the body to drive the front wheel 4 to make the bicycle run faster. While using his or her arms and hands to drive the front wheel 4 forward, the cyclist controls the forward direction of the bicycle through the rotation of the handlebar 14 to make the front fork 3 and the front wheel 4 rotate. As the front fork 3 rotates, if the cyclist presses the shoulders on the bracket 1, then the bracket 1 remains perpendicular to the frame 7 and doesn't rotate along with the front fork 3.

When cyclist walks to move forward the two-wheel driven bicycle as the preferred embodiment of the present invention, he or she takes hold of the bracket 1 and the bracket 1 is left less pressed, yet the friction between the stem of the bracket 1 and the stem of the front fork 3 is large enough to make the front wheel turn while bringing the front fork 3 into rotation.

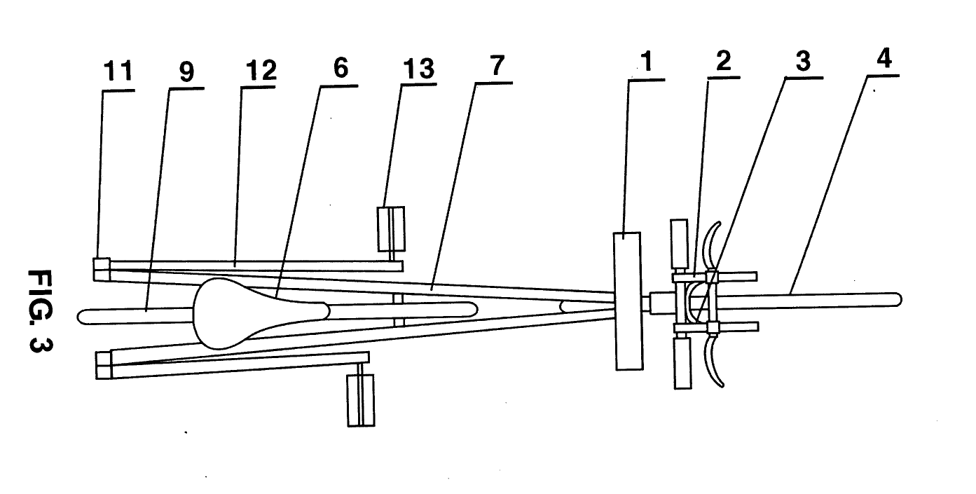

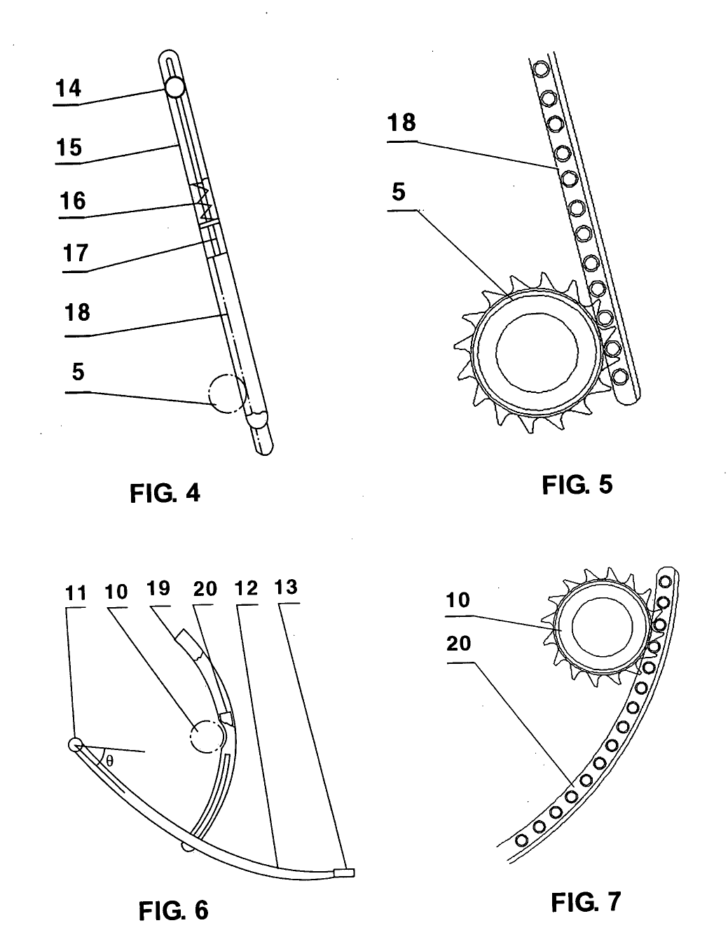

The two-wheel driven bicycle as the preferred embodiment of the present invention has two sets of the front-wheel driver unit mechanism 2, mounted respectively on the right and left side of the front fork 3. FIG. 4 illustrates the structure of the front-wheel driver unit mechanism 2 on the right side, wherein are the handlebar 14 of the front-wheel driver unit mechanism 2, the crust 15 of the front wheel driver unit, the spring means 16, the connecting rod 17, the front wheel driver unit 18, and the front-wheel ratchet wheel 5. FIG. 5 illustrates the front-wheel driver unit 18 and the front-wheel ratchet wheel 5 of the two-wheel driven bicycle as the preferred embodiment of the present invention. The front-wheel driver unit 18 is a rectilinear metal strip within which bar rollers are inserted at equal space which equals the tooth pitch of the front-wheel ratchet wheel 5. The front-wheel driver unit 18 meshes with the front-wheel ratchet wheel 5 and moves downward to directly drive the front-wheel ratchet wheel 5 and the front wheel 4.

The crust 15 of the front-wheel driver unit 18 has a longitudinal opening on the side of its upper part to allow the handlebar 14 to move downward. The front-wheel driver unit 18 is able to move neatly inside the crust 15. The handlebar 14 is linked to the upper end of the connecting rod 17, and the lower end of the connecting rod 17 is linked to the front-wheel ratchet wheel 18. Usually the handlebar 14 under the elasticity of the spring means 16 stays above the upper end of the crust 15, and as the cyclist is ready to drive the front wheel 4, he or she grips the handlebar 14 and pushes it downward, then the handlebar 14 propels the connecting rod 17 to make the front-wheel driver unit 18 move downward to directly drive the front-wheel ratchet wheel 5 and the front wheel 4. The front-wheel driver unit 18 returns to its origin by depending on the cyclist withdrawing his or her arms and the elasticity of the spring means 16. As the front wheel 4 is being driven, if the handlebar 14 turns, then the front fork 3 and the front wheel 4 rotate in sync, allowing the cyclist to control the forward direction of the bicycle all the time through the handlebar 14.

The two-wheel driven bicycle as the preferred embodiment of the present invention has two sets of the rear-wheel driver unit mechanism 8, mounted respectively on the right and left side of the rear fork. FIG. 6 illustrates the structure of the rear-wheel driver unit mechanism 8, wherein are the crank shaft 11, the rear-wheel ratchet wheel 10, the crust 19 of the rear-wheel driver unit, the rear-wheel driver unit 20, the crank 12, and the pedal 13. FIG. 7 illustrates the rear-wheel driver unit 20 and the rear-wheel ratchet wheel 10 of the two-wheel driven bicycle as the preferred embodiment of the present invention. The rear-wheel driver unit 20 is a curvilinear metal device within which bar rollers are inserted at equal distance which equals the tooth pitch of the rear-wheel ratchet wheel 10. The rear-wheel driver unit 20 meshes with the rear-wheel ratchet wheel 10 and moves downward along a curve to directly drive both the rear-wheel ratchet wheel 10 and the rear wheel 9.

The rear-wheel driver unit 20 is curvilinear in shape and so is the crust 19 of the rear-wheel driver unit. The rear-wheel driver unit 20 is able to move neatly within the crust 19 of the rear-wheel driver unit. The crust 19 of the rear-wheel driver unit has a curvilinear opening on the side of its lower part to allow the crank 12 to move downward. The lower end of the rear-wheel driver unit 20 is fixed to the mid point of the crank 12, and the pedal 13 is fixed to the right end of the crank 12. The cyclist applies force with the legs and propels the pedal 13 with the feet, and the pedal 13 in turn drives the crank 12 to go around the crank shaft 11, and the crank 12 makes the rear-wheel driver unit 20 to move downward along a curve around the crank shaft 11 to directly drive the rear-wheel ratchet wheel 10 and the rear wheel 9.

The rear-wheel driver unit 20 moves until the lower end of the crust 19 of the rear-wheel driver unit 20, and the crust 19 of the rear-wheel driver unit 20 works to bound the crank 12 and the pedal 13.

The crank shaft 11 has inside itself a spring means that works to return both the crank 11 and the rear-wheel driver unit 20 to return to their origins. The cyclist can also make use of a pair of shoes fitting closely into the pedal 13 to restore the crank 11 and the rear-wheel driver unit 20 to their origins. Moreover, a steel wire going across a pulley fixed to the bicycle frame may be used to link together the right and left pedals so that one pedal going downward pulls the other pedal upward to restore the rear-wheel driver unit 20 to its origin. What is described in this paragraph is readily understandable to those familiar with the art and needs no further graphical illustration.

As for the rear-wheel driven bicycle driven directly through the driver unit as the second preferred embodiment of the present invention, its front wheel, which is not equipped with a drive system, is identical to that of a conventional bicycle, and its handlebar, where there is no the bracket 1 mounted above the head tube, is also identical to that of a conventional bicycle, yet its rear-wheel drive mechanism is just the same as the rear-wheel driver unit mechanism 8 of the preferred embodiment of the present invention.

The third preferred embodiment of the present invention is: the front wheel is equipped with the front-wheel driver unit mechanism 2 of the preferred embodiment of the present invention, and a bracket 1 is offered to support the upper part of the cyclist's body, while the rear wheel is equipped with the pedal-crank-chain-wheel-chain drive system of a conventional bicycle.

The fourth preferred embodiment of the present invention: the front wheel is equipped with something other than the front-wheel driver unit mechanism 2 of the preferred embodiment of the present invention, and the rear wheel is equipped with the rear-wheel driver unit mechanism 8 of the preferred embodiment of the present invention.

The front-wheel driver unit mechanism 2 is employed to drive the front wheel in the preferred embodiment of the present invention but not limited to being used to drive the front wheel in other preferred embodiments of the present invention.

The rear-wheel driver unit mechanism 8 is employed to drive the rear wheel in the preferred embodiment of the present invention but not limited to being used to drive the rear wheel in other preferred embodiments of the present invention.

The second, third and fourth preferred embodiments of the present invention are believed easily understandable and are not otherwise illustrated graphically.

What is claimed is:

1. A bicycle driven through said driver units is characterized by: the rectilinear driver unit of Wheel A directly drives the ratchet wheel of Wheel A and Wheel A itself through engaging the ratchet wheel of Wheel A; or the curvilinear driver unit of Wheel B directly drives the ratchet wheel of Wheel B and Wheel B itself through engaging the ratchet wheel of Wheel B.

2. The bicycle of claim 1 driven through said driver units is characterized by: said driver unit of Wheel A is a rectilinear metal strip in which rollers are embedded at an equal distance, and said driver unit of Wheel B is a curvilinear metal device in which rollers are embedded at an equal distance.

3. The bicycle of claim 1 driven through said driver units is characterized by: there a two sets of said driver unit mechanism for Wheel A, mounted on both left and right side of the fork of Wheel A; said mechanism comprises the handlebars, the crust of said driver unit of Wheel A, the spring means, the connecting rod linked to said handlebars, and said driver unit and said ratchet wheel of Wheel A that are both linked to said connecting rod. Said driver unit of Wheel A is placed inside said crust of said driver unit, and said crust has a vertical and downward opening on the external side of its upper part, and said driver unit of Wheel A meshes with said ratchet wheel of Wheel A on the same side.

4. The bicycle of claim 2 driven by said driver unit is characterized by: said driver unit of Wheel A is situated at the lower part of its crust, and said crust has a long opening at the external side of its upper part and is open with its lower part.

5. The bicycle of claim 2 driven by said driver units is characterized by: said handlebar of said drive mechanism of said driver unit of Wheel A is linked to the upper end of said driver unit of Wheel A through said connecting rod, and said connecting rod is surrounded by said spring means.

6. The bicycle of claim 2 driven by said driver unit is characterized by: as said handlebar of said drive mechanism of said driver unit of Wheel A turns, said Wheel A rotates in sync.

7. The bicycle of claim 1 driven through said driver units is characterized by: if both said Wheel A and said Wheel B are equipped with said driver unit mechanisms, then a bracket has to be mounted above the head tube of said bicycle.

8. The bicycle of claim 1 driven through said driver units is characterized by: there a two sets of said driver unit mechanism for Wheel B, mounted on both left and right side of the fork of Wheel B; said mechanism comprises the crank shaft, said ratchet wheel of Wheel B, the crust of said driver unit of Wheel B, said driver unit of Wheel B, and the crank that is connected to said crank shaft at one end and the pedal at the other end. Both said crust of said driver unit and said driver unit itself of said Wheel B are curvilinear, and said driver unit of Wheel B is able to move neatly within its said crust. Said crust of said driver unit of Wheel B has a curve-shaped opening on the side of its lower part, and said driver unit of Wheel B is linked to the mid point of said crank shaft through the opening. Said driver unit of Wheel B engages said ratchet wheel of Wheel B on the same side.

9. The bicycle of claim 7 driven through said driver units is characterized by: the inner part of said crank shaft is fitted with said spring means which enables said crank to bring said driver unit of Wheel B back to its origin.

10. The bicycle of claim 7 driven through said driver units is characterized by: said driver unit of Wheel B relies on the elasticity of said spring means, the shoes that can fit neatly into said pedal, and the steel wire to return to its origin.
